(19) United States
(12) Patent Application Publication
(10) Pub. No.: US 2010/0022739 A1
(43) Pub. Date: Jan. 28, 2010

(54) Impression Compounds

(75) Inventors: Hartmut Nefzger, Pulheim (DE); Erika Bauer, Juchen (DE); Michael Ludewig, Leverkusen (DE); Matthias Schaub, Freigericht (DE); Klaus-Dieter Nehren, Dormagen (DE); Michael Freckmann, Koln (DE); Holger Urbas, Krefeld (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: HERAEUS KULZER GMBH, Hanau (DE)

(21) Appl. No.: 12/515,775

(22) PCT Filed: Nov. 23, 2007
(86) PCT No.: PCT/EP2007/010169

§ 371 Date: Jul. 13, 2009

(30) Foreign Application Priority Data
Nov. 25, 2006 (DE) 10 2006 055 739.5

(51) Int. Cl. C08G 77/04

(52) U.S. Cl. 528/28

(57) ABSTRACT

The present invention relates to impression compounds based on polyether derivatives, a process for their production and their use.

The present invention relates to impression compounds based on polyether derivatives, a process for their production and their use.

Impression compounds which are based on polyether derivatives and used in the dental sector have been known for a long time. In line with the state of the art, pastes are used whose components comprise polyether polyols, polyisocyanates and amino siloxanes, for example, as well as additional fillers and further auxiliaries.

Cross-linking of the compounds takes place by the hydrolysis of alkoxysilane groups, for example, by moisture in the surroundings or added in a controlled manner and subsequent cross-linking with the formation of siloxane groups.

The requirements which dental impression compounds have to satisfy are exacting. EP-A 0 269 819 mentions, among other things, a pleasant taste and odour, an aesthetic appearance, good storage stability, good handleability, accuracy of the impression, useful hardening characteristics and moulded bodies which are dimensionally stable under ambient conditions. Moreover, such compounds must not contain irritant or toxic components. Fully cured compounds must obviously exhibit an excellent compression moulding behaviour and, as far as possible, no hysteresis under tensile stress. In addition, it must be possible to produce them in an economically advantageous manner.

Previous solutions for this task include alginate impression compounds, for example, which have the disadvantage of comparably strong shrinkage. Polysulphide impression compounds are dark in colour and, in addition, contain lead compounds or copper compounds as catalysts. Polyether impression compounds contain ethylene imine cross-linking agents. Polysiloxane impression compounds occasionally provide faulty impressions as a result of the moisture present in the oral cavity.

The nearest state of the art is disclosed in EP-A 1 245 601 and EP-A 0 269 819. According to EP-A 1 245 601, the production first of all of an NCO prepolymer from a polyol and an aliphatic, cycloaliphatic or aromatic polyisocyanate is described which is characterised in that no metal catalysis is carried out. This is true also of the second stage of the reaction of this NCO prepolymer with secondary amine-terminated aminoalkyl alkoxysilane.

Obviously, this procedure is not universally applicable, in particular when the polyol used for the NCO prepolymer does not contain OH groups exclusively or at least predominantly. The expert knows that particularly when using cycloaliphatic diisocyanates such as isophorone diisocyanate with polyether polyols which contain primary OH groups not exclusively or predominantly, this teaching leads to economically unacceptably long reaction times for prepolymer production. This applies also to the reaction of such NCO prepolymers with amine-terminated aminoalkyl alkoxysilane. In this case, lengthy and consequently uneconomic phases take place, e.g. when dibutyl tin dilaurate catalysis is used, during which phases free amine is present, apart from free isocyanate. For dental applications, the more reactive aromatic polyisocyanates are entirely unsuitable because of their toxicity. Free isocyanate, be it of an aromatic or aliphatic nature, is obviously and in principle just as unacceptable as an excess of amino siloxane beyond an absolute minimum. Free isocyanates are, moreover, not acceptable since they would continue to react slowly over time, e.g. following compounding with additives and auxiliary agents, as a result of which the consistency of the pastes could change slowly and, consequently, the stability in storage could no longer be guaranteed.

Some of the last-mentioned aspects have already been described in EP-A 0 269 819. However, EP-A 0 269 819 does not describe whether and, if applicable, what type of catalyst should be advantageously used for the complete reaction of the NCO groups. Only tin octoate is used in two practical examples.

However, tin compounds cause problems as a result of corrosion effects during storage in certain packaging materials such as aluminium tubes or tubular bags based on aluminium. In addition, toxicological concerns have increasingly been voiced recently regarding organotin compounds. There is therefore a requirement for dental impression compounds which preferably contain no tin compounds in which, however, at least the content of tin compounds is reduced to a minimum, e.g. 5 ppm, i.e. limited in terms of their order of magnitude to approximately 10% of the quantities commonly used at present according to the state of the art. No solution to this problem is discernible in the teaching of EP-A 0 269 819.

The same is true for EP-A 0 096 249, EP-A 0 158 893, U.S. Pat. No. 4,374,237 and U.S. Pat. No. 3,632,557, DE-A 4 307 024, EP-A 0 687 280, DE-A 4 439 769, DE-A 10 201 703, EP-A 1 563 822, EP-A 1 563 823 as well as EP-A 1 226 808, EP-A 1 402 873 and EP-A 1 081 191.

Moreover, EP-A 0 269 819 teaches that those polyethers are preferably used which exhibit predominantly, i.e. up to 90%, primary OH end groups, based on all the OH end groups present. The only polyether polyols of economic relevance are those made from ethylene oxide and/or propylene oxide, apart from the polytetrahydrofurans. Polytetrahydrofurans are less suitable for dental applications since they exhibit a phase transition in the room temperature region which leads to the flow and consequently the processing properties being temperature-dependent to an undesirably strong extent within the region of the application temperature. A further disadvantage in comparison with types based on ethylene-propylene oxide is their high price. In the case of polyethers based on ethylene-propylene oxide, a high proportion of primary OH groups is obviously obtained only by a relatively large proportion of ethylene oxide units being polymerised, if necessary in mixture with propylene oxide as end block on polypropylene oxide during the manufacture of such polyethers. This structure in turn leads to an undesirably high hydrophily which has a strongly negative effect on the water absorption behaviour and consequently the stability in storage of the paste produced therewith. It is therefore desirable in this respect to be able to use polyethers with as few structural ethylene oxide elements as possible while still guaranteeing acceptable reaction times.

The present invention was therefore based on the object of providing an impression compound system based on silane-terminated polyether derivatives for the dental sector which, as far as possible, contains no tin compounds or has a maximum content of tin compounds of <5 ppm, this impression system having to be economically producible and to satisfy all requirements regarding dental impression compounds mentioned above.

Surprisingly enough it has been found that this object can be achieved in an excellent manner by means of silane-terminated polyethers which are produced essentially or completely without catalysis by tin compounds.

The subject matter of the invention consequently consists of silane-terminated polyether derivatives obtainable by the reaction of
a.) largely linear polyether polyols with predominantly secondary OH groups by means of catalysts with
b.) diisocyanates
   to prepolymers with an NCO content of 0.5 to 6% by weight NCO, preferably 1 to 4% by weight NCO, and further reaction of these prepolymers in a second reaction step with
c.) compounds containing amino groups with the general formula (i)

HNR—(CH₂)ₙ—SiR₁R₂R₃, (i)
in which
R represents hydrogen or —(CH₂)ₙ—SiR₁R₂R₃,
n is an integer of 1 to 6 and
at least one of the R₁, R₂, R₃ groups has the structure (—O—CₚH₂ₚ)_{q}—OR₄,
in which
p has a value of 2 to 5, preferably 3, and
q has a value of 0 to 100, preferably 0 to 4 and
R₄ represents a substituent selected from the group comprising alkyl, aryl, arylaklyl, vinyl or vinyl carbonyl
and
the remaining groups R₁, R₂, R₃ are alkoxy radicals with 1 to 4 C atoms,
which are reacted in such a way that the NCO value is less than 0.001% by weight NCO and the proportion of free amino groups is adjusted to within the range of 0.5 to 50 mmol, preferably 1 to 15, particularly preferably 0.5-5 mmol amino groups per kg of the silane-terminated polyether derivative thus obtained.

A further object of the invention consists of a process for the production of silane-terminated polyether derivatives characterised in that
a.) largely linear polyether polyols with predominantly secondary OH groups are reacted by means of catalysts with
b.) diisocyanates
   to prepolymers with an NCO content of 0.5 to 6% by weight NCO, preferably 1 to 4% by weight NCO and the further reaction of these prepolymers in a second action step with
c.) compounds containing amino groups with the general formula (i)

HNR—(CH₂)ₙ—SiR₁R₂R₃, (i)
in which
R represents hydrogen or -(CH₂)ₙ—SiR₁R₂R₃,
n is an integer of 1 to 6 and
at least one of the R₁, R₂, R₃ groups has the structure (—O—CₚH₂ₚ)_{q}—OR₄,
in which
p has a value of 2 to 5, preferably 3, and
q has a value of 0 to 100, preferably 0 to 4 and
R₄ represents a substituent selected from the group comprising alkyl, aryl, arylaklyl, vinyl or vinyl carbonyl
and
the remaining groups R₁, R₂, R₃ are alkoxy radicals with 1 to 4 C atoms,
in such a way that the NCO value is less than 0.001% by weight NCO and the proportion of free amino groups is adjusted to within the range of 0.5 to 50 mmol, preferably 1 to 15, particularly preferably 0.5-5 mmol amino groups per kg of the silane-terminated polyether derivative thus obtained.

The invention is described in further detail as follows:

According to the process of the invention for the production of silane-terminated polyether derivatives, largely linear polyether polyols with more than 80% secondary OH groups are reacted by means of zinc catalysts in a first reaction step by reaction with aliphatic polyisocyanates to form a prepolymer with a NCO content of 0.5 to 6% by weight NCO, preferably 1 to 4% by weight NCO.

Largely linear polyether polyols with more than 80% secondary OH groups are those polyols which are prepared by ring opening polymerisation from epoxides, e.g. ethylene oxide and propylene oxide, preferably entirely or predominantly propylene oxide, by means of e.g. KOH or double metal catalysts (DMC) as catalysts using starters exhibiting reactive hydrogen atoms from the group of polyalcohols and polyamines and water. These largely linear polyether polyols are those with a hydroxyl functionality of 1.95 to 2.3, preferably 1.96 to 2.06.

Divalent starters such as ethylene glycol, propylene glycol-1,2, propylene glycol-1,3, diethylene glycol, butylene glycol-1,4, butylene glycol-2,3,1,6-hexane diol, glycerine, 1,1,1-trimethylol propane and water are preferred. Starters according to the invention also comprise mixtures of several starters, the starter mixtures being composed such that polyether polyols with an OH functionality of not more than 2.5, preferably not more than 2.2, are formed.

If more than one epoxide is used, the polymerisation may be carried out either in blocks or mixed. However, the use of only one epoxide, particularly preferably propylene oxide, and mixtures of two epoxides is preferred, the mixtures consisting predominantly of propylene oxide.

Polyether polyols according to the invention are, in addition, characterised in that they have number average molecular weights of 150 to 20000 Da, preferably 500 to 6500 DA, particularly preferably 800 to 5500. Obviously, mixtures of at least two polyether polyols can advantageously be used, the number average molecular weight of the mixture being in this case within the range described above.

Examples of aliphatic polyisocyanates are 4,4′-methylene bis(cyclohexyl isocyanate), ethylene diisocyanate, tetramethylene diisocyanate, hexamethylene diisocyanate, dodecamethylene diisocyanate, cyclobutane-1,3 diisocyanate, cyclohexane-1,3 diisocyanate, cyclohexane-1,4 diisocyanate or 1 -isocyanato,3,3,5-trimethyl 5-isocyanatomethyl cyclohexane (isophorone diisocyanate, IPDI). They can be used individually or in mixture although IPDI is particularly preferred.

In a first reaction stage, the polyethers according to the invention are reacted with polyisocyanates according to the invention in line with the state of the art at temperatures within the range of 60 to 150° C., preferably 80 to 110° C., preferably using a protective gas, particularly preferably nitrogen, at normal pressure to reduced pressure, preferably at normal pressure, to form NCO prepolymers, it being possible to use a solvent inert vis-à-vis NCO groups, while preferably no solvent is used.

To accelerate the reaction, catalysts are used according to the invention. Preferred catalysts, if necessary catalyst mixtures, are characterised in that the silane-terminated polyether derivatives exhibit maximum quantities of tin compound of 5 ppm. The use of catalysts exhibiting entirely or predominantly zinc as metal atom is preferred. Zinc acetate, zinc citrate, zinc lactate, zinc stearate, zinc undecylenate are examples of catalysts according to the invention, zinc di-tert-butyl salicylate, zinc acetyl acetonate and zinc neodecanoate being preferred. The catalysts are advantageously used in quantities of 0.5 to 10 mg Zn/kg prepolymer.

The prepolymers according to the invention have NCO contents of 0.5 to 6% by weight NCO, preferably 1 to 4% by weight NCO.

The formation of prepolymer is considered as completed if the NCO content determined in practice reaches the theoretically calculated NCO value.

The NCO prepolymers according to the invention are then reacted with alkoxysilyl monoamines in a second reaction stage. Suitable alkoxysilyl monoamines are known. The technically easily accessible γ-aminopropyl tri-C₁-C₄-alkoxysilanes or bis-(3-C₁-C₄-alkoxysilyl propyl) amines, such as e.g. γ-aminopropyl trimethoxysilane and γ-aminopropyl triethoxysilane, for example, are suitable example.

The reaction of NCO prepolymer and alkoxysilyl monoamine to give reactive silane-terminated polyether derivatives is carried out in such a way that no NCO is detectable any longer in the silane-terminated polyether derivative and the proportion of free amino groups is in the range of 0.5 to 50 mmol, preferably 1 to 15, particularly preferable 0.5-5 mmol amine groups per kg of silane-terminated polyether derivatives.

These targets are preferably achieved according to the invention by initially stirring in a stoichiometric excess of alkoxysilyl monoamine which is mathematically suitable to increase the NCO value to 0 and the amine value to a value of preferably 0.5 to 5 mmol per kg of silane-terminated polyether derivative at elevated temperature, preferably at least 50° C. and allowing it to react. At this stage of the reaction, both free amine and free isocyanate are encountered. After approximately 2 hours, the amine content and the NCO content are determined hourly. The reaction is deemed to have been completed if one of the values of two subsequent measurements remains unchanged. If the amine value is within the desired range and the NCO value is simultaneously 0, the product is ready for use. If the amine value is 0 and the NCO value>0, a quantity of alkoxysilyl monoamine is metered in which is sufficient to increase the amine value to within the region of 0.5 to 5 mmol amine groups per kg.

If the amine value is above the desired range and the NCO value is zero, a quantity of aliphatic monoisocyanate is metered in which, according to calculation, is sufficient to reduce the amine value to the desired range.

The use of aliphatic monoisocyanate instead of (alternatively) IPDI with at least one very slowly reacting NCO group represents a major advantage in terms of time.

In a further and preferred variation according to the invention, the state of a silane-terminated polyether derivative with an NCO value of zero and an amine value in the region of 0.5 to 5 mmol amino groups per kg of silane-terminated polyether derivative is achieved by initially adding a hyperstoichiometric quantity of alkoxysilyl monoamine and, if necessary, by additionally metering in of the same, adjusting the proportion of amine groups to a constant value of more than 2 mmol amine groups per kg of polyurethane compound, particularly preferably 2 to 5 mmol amine group per kg of polyurethane compound and reducing this value of more than 2 mmol by the addition of a hypostoichiometric quantity, based on the amine groups, of an aliphatic isocyanate, preferably monoisocyanate with at least 2 carbon atoms, preferably at least 6 carbon atoms, such as e.g. 1-n-octyl isocyanate, 1-n-decyl isocyanate, 1-n-dodecyl isocyanate or 1-stearyl isocyanate with reference to the proportion of free amino groups, to values below 2 mmol/kg by reaction.

Obviously, it is possible by means of the process according to the invention to adjust a different status than the one above concerning the NCO value and the amine group concentration.

The impression compounds according to the invention based on silane-terminated polyether derivatives are provided with further auxiliary agents and additives in line with the state of the art in order to change them into a form suitable for use.

The following can be mentioned as examples: fillers, dyes, pigments, thickeners, surfactants, aromas and flavourings as well as thinners.

Water is required for the setting reaction in the oral cavity. In order to adjust practicable setting times, acids are added as catalytically active components. Dental impression compounds according to the invention are preferably supplied as two-component systems, one component containing the silane terminated polyether derivatives and, if necessary, further auxiliary agents and additives and the other component water, one or several acidic components and, if necessary, auxiliary agents and fillers.

It is surprising that
the silane-terminated polyether derivatives described above and produced by Zn catalysis exhibit a comparable molecular weight distribution to silane-terminated polyether derivatives produced by the catalysis of tin compounds and exhibiting contents of tin compounds of >5ppm;
the systems according to the invention exhibit a comparable or more favourable stability in storage;
dental impression compounds can be obtained by means of the silane-terminated polyether derivatives used according to the invention which compounds satisfy the basic requirements regarding impression materials and which do not differ substantially with respect to their physical and application-technical properties profile from the compounds according to the state of the art with contents of tin compounds of >5 ppm.

The following examples illustrate the invention further and bring to light the technical effects connected therewith.

### EXAMPLE 1 (According to the Invention)

### Production of the Polyurethane Compounds

2553 g of a polypropylene oxide which has been dewatered previously in a water jet vacuum and has an OH number of 28 mgKOH/g (Acclaim® 4200N (Bayer MaterialScience AG)) were heated to 100° C., 236 g of isophorone diisocyanate (IPDI) were added with stirring under protective gas within 2 minutes. After 5 minutes, 100 mg of zinc di-tert. butyl salicylate were added. Stirring was continued for a further 2 hours at 100° C. and the NCO content of the NCO prepolymer was determined as being 1.20% by weight of NCO (theoretical: 1.28% by weight).

Cooling to 40° C. was allowed to take place and the NCO content was determined anew (1.20% by weight of NCO).

170 g of Dynasilan® Ameo (bonding agent TP 3023, Degussa AG) were stirred into this viscous reaction mass at 40° C. The proportion of free amine was determined after 2 hours and after 3 hours as being 0.5 mmol amine/kg.

A further 1 g of Dynasilan® Ameo was stirred in, the amine contained being determined after 2 hours and 3 hours as being 0.4 mmol amine/kg.

A further 2 g of Dynasilan® Ameo were stirred in, the amine contained being determined after 2 hours and 3 hours as being 0.3 mmol amine/kg.

A further 4 g of Dynasilan® Ameo were stirred in, the amine contained being determined after 2 hours and 3 hours as being 1.8 mmol amine/kg.

The increase in the proportion of free amine following the last addition of Dynasilan® Ameo indicates that all NCO groups had fully reacted.

The NCO value was determined at that point in time as being 0% by weight of NCO. The amine content determined after a further 24 hours remained constant at 1.8 mmol amine/kg.

### EXAMPLE 2 (According to the Invention)

### Production of the Polyurethane Masses

2550 g of a polypropylene oxide which has been dewatered previously in a water jet vacuum and has an OH number of 28 mgKOH/g (Acclaim® 4200N (Bayer MaterialScience AG)) were heated to 100° C., 283 g of isophorone diisocyanate (IPDI) were added with stirring under protective gas within 2 minutes. After 5 minutes, 80 mg of zinc di-tert. butyl salicylate were added. Stirring was continued for a further 2 hours at 100° C. and the NCO content of the NCO prepolymer was determined as being 1.83% by weight of NCO (theoretical: 1.89% by weight).

Cooling to 40° C. was allowed to take place and the NCO content was determined anew (1.83% by weight of NCO).

273 g of Dynasilan® Ameo were stirred into this viscous reaction mass at 40° C. The proportion of free amine was determined after 2 hours and after 3 hours as being 1.99 mmol amine/kg.

A further determination of the content of free amine after 24 hours gave the proportion of free amine as being 1.98 mmol amine/kg. The NCO value was determined at this point in time as being 0% by weight of NCO.

### REFERENCE EXAMPLE 1 (RE1, Not According to the Invention)

The same procedure as in example 1 is used; however, instead of Zn tert. butyl salicylate, 150 mg of dibutyl tin dilaurate were added as catalyst.

After stirring for 2 hours at 100° C., the NCO content of the NCO prepolymer was determined as being 1.25% by weight of NCO (theoretical 1.28% by weight).

This was allowed to cool to 40° C. and the NCO content determined anew (1.25% by weight NCO).

180 g of Dynasilan® Ameo were stirred into this viscous reaction mass at 40° C. After 2 hours and 3 hours, the proportion of free amine was determined as being 0.11 mmol amine/kg.

A further 2.7 g of Dynasilan® Ameo were stirred in, the amine content being determined after 2 hours and 3 hours as being 2.96 mmol amine/kg.

0.45 g of octyl isocyanate were stirred in, the amine content being determined after 2 hours and 3 hours as being 1.74 mmol amine/kg.

At that point in time, the NCO value was determined as being 0% by weight NCO. The amine content determined after a further 24 hours was a constant 1.74 mmol amine/kg.

### REFERENCE EXAMPLE 2 (RE2, Not According to the Invention)

The same procedure as in example 1 is used; however, instead of Zn tert. butyl salicylate, 150 mg of dibutyl tin dilaurate were added as catalyst.

After stirring for 2 hours at 100° C., the NCO content of the NCO prepolymer was determined as being 1.82% by weight of NCO (theoretical 1.89% by weight).

This was allowed to cool to 40° C. and the NCO content was determined anew (1.82% by weight NCO).

269 g of Dynasilan® Ameo were stirred into this viscous reaction mass at 40° C. After 2 hours and 3 hours, the proportion of free amine was determined as being 0.3 mmol amine/kg.

A further 1 g of Dynasilan® Ameo of was stirred in, the amine content being determined after 2 hours and 3 hours as being 1.52 mmol amine/kg.

At that point in time, the NCO value was determined as being 0% by weight NCO.

To assess the molecular weight distribution, investigations by gel permeation chromatography were carried out. These showed that the molecular weight distribution of B1 matched that of RE1 and that of B2 matched RE2 to a large extent.

### Investigation of the Stability in Storage

The products from examples 1, 2 and reference examples RE1 and RE2 were packaged in an airtight manner and stored at 60° C. To assess the stability in storage, the change in viscosity were determined.

The silane-terminated polyether derivatives used according to the invention are characterised by a similar or lower viscosity change and consequently by a comparable or higher stability in storage.

TABLE 1
Determination of the stability in storage of
silane-terminated polyether derivatives

| | | | | Viscosity | Viscosity |
|---|---|---|---|---|---|
| | | | Viscosity | (23° C., 3 s⁻¹) | (23° C., 3 s⁻¹) |
| silane- | | | (23° C., 3 s⁻¹) | after storage | after storage |
| terminated | Content of tin | Content of | directly after | for 1 month | for 2 months |
| polyether | compound | zinc compound | production | at 60° C. | at 60° C. |
| derivative | [ppm] | [ppm] | [Pas] | [Pas] | [Pas] |
| According | 0 | 33 | 127 | 148 | 167 |
| to example 1 | | | | | |
| According | 0 | 26 | 103 | 122 | 115 |
| to example 2 | | | | | |
| According | 50 | 0 | 126 | 161 | 185 |
| to RE 1 | | | | | |
| According | 50 | 0 | 100 | 131 | 146 |
| to RE 2 | | | | | |

Table 1 shows that systems can be obtained according to the invention the stability in storage of which is at least equivalent to those conventionally catalysed but superior during prolonged storage.

### Examples of Formulation

A. Production of the Basic Components

In a laboratory dissolver, 20 parts by weight of the silane-terminated polyether derivatives were mixed with 20 parts by weight of dibenzyl toluene, 56 parts by weight of quartz meal and 4 parts by weight of hydrogenated castor oil for 3 hrs at a pressure of <50 mbar to form a homogeneous paste-type mass.
B. The production of the Catalysts Components Takes Place According to DE-Al 0 104 079, Example 3.

The various basic components were mixed with the catalyst component in a weight ratio of 5:1 respectively. The processing times (according to DIN EN ISO 4823), hardnesses according to Shore A (according to DIN 5305) and the tear strengths (according to DIN 53504) of the mixtures were determined. The compositions according to the invention matched the profile of characteristics of compounds produced by tin catalysis. The tin-free impression compounds according to the invention satisfy the essential requirements regarding dental impression compounds (according to ISO 4823).

TABLE 2
Recipes for the production of dental impression compounds
and testing of important characteristics

| | | | Reference |
|---|---|---|---|
| | | According | example |
| | | to the | not according |
| | | invention | to the invention |
| Recipe: | | | |
| B 1 | [Parts] | 10 | |
| B 2 | [Parts] | 10 | |
| RE1 | [Parts] | | 10 |
| RE2 | [Parts] | | 10 |
| Dibenzyl toluene | [Parts] | 20 | 20 |
| Quartz meal | [Parts] | 56 | 56 |
| Hydrogenated castor | [Parts] | 4 | 4 |
| oil | | | |
| Content of tin compound | [ppm] | <2 | 10 |
| Content of zinc compound | [ppm] | 6 | <2 |
| Characteristics: | | | |
| Processing time | [min] | 1.8 | 1.8 |
| Setting time | [min] | | |
| Postponement of | [%] | 98.5 | 98.6 |
| moulding | | | |
| Moulding under pressure | [%] | 4.0 | 4.1 |
| Shore-A (1 h) | [Shore A] | 61 | 57 |
| Tear strength | [MPa] | 2.9 | 2.6 |

1. Silane-terminated polyether derivatives prepared by the catalytic reaction of
a.) predominantly linear polyether polyols having predominantly secondary OH groups with
b.) diisocyanates
to form prepolymers with an NCO content of 0.5 to 6% by weight NCO, and further reaction of these prepolymers in a second reaction step with
c.) compounds containing amino groups with the general formula (i)
HNR—(CH₂)ₙ—SiR₁R₂R₃, (i)
in which
R represents hydrogen or —(CH₂)ₙ—SiR₁R₂R₃,
n is an integer of 1 to 6 and
at least one of the R₁, R₂, R₃ groups has the structure (—O—CₚH₂ₚ)_{q}—OR₄,
in which
p has a value of 2 to 5, and
q has a value of 0 to 100, and
R₄ represents a substituent selected from the group consisting of alkyl, aryl, arylaklyl, vinyl and vinyl carbonyl
and
the remaining groups R₁, R₂, R₃ are alkoxy radicals with 1 to 4 C atoms,
in such a way that the NCO value is less than 0.001% by weight NCO and the proportion of free amino groups is adjusted to within the range of 0.5 to 50 mmol amino groups per kg of the silane-terminated polyether derivative thus obtained.

2. Silane-terminated polyether derivatives according to claim 1 wherein the proportion of free amino groups is adjusted within the range of 1 to 15 mmol amino groups per kg of the silane-terminated polyether derivative thus obtained.

3. Silane-terminated polyether derivatives according to claim 1 wherein the proportion of free amino groups is adjusted within the range of 0.5-5 mmol amino groups per kg of the silane-terminated polyether derivative thus obtained.

4. Process for the production of silane-terminated polyether derivatives wherein
a.) predominantly linear polyether polyols having predominantly secondary OH groups are reacted in the presence of catalysts with
b.) diisocyanates
to form prepolymers with an NCO content of 0.5 to 6% by weight NCO, and the prepolymers are further reacted, in a second reaction step with
c.) compounds containing amino groups with the general formula (i)
HNR—(CH₂)ₙ—SiR₁R₂R₃, (i)
in which
R represents hydrogen or —(CH₂)ₙ—SiR₁R₂R₃,
n is an integer of 1 to 6 and
at least one of the R₁, R₂, R₃ groups has the structure (—O—CₚH₂ₚ)_{q}—OR₄,
in which
p has a value of 2 to 5, and
q has a value of 0 to 100, and
R₄ represents a substituent selected from the group consisting of alkyl, aryl, arylaklyl, vinyl and vinyl carbonyl
and
the remaining groups R₁, R₂, R₃ are alkoxy radicals with 1 to 4 C atoms,
under conditions which produce silane-terminated polyether derivatives having an NCO value less than 0.001% by weight NCO and a proportion of free amino groups is adjusted to within the range of 0.5 to 50 mmol, amino groups per kg of the silane-terminated polyether derivative thus obtained.

5. Process according to claim 4 wherein tin compounds are used for the production of the NCO prepolymers in proportion of maximum 5 ppm together with at least one further catalytically active species.

6. Process according to claim 4 wherein the NCO prepolymers are produced by using quantities of catalysts of 0.5 to 10 mg Zn/kg.

7. Process according to claim 4, wherein the NCO prepolymers are produced at temperatures of 60 to 150° C. under protective gas.

8. Process according to claim 4 wherein the adjustment of the NCO value and the amine group concentration to values below 0.001% by weight NCO and, simultaneously, to more than 2 mmol amine groups per kg takes place by using an aliphatic isocyanate.

9. A method for the production impression compounds which comprises producing said impression compounds with a silane-terminated polyether derivative of claim 1.

10. Method according to claim 9 wherein the impression compounds are dental impression compounds.

11. Method according to claim 9 wherein the materials are provided in the form of two separate components which are mixed before use.

12. The process of claim 5, wherein said at least one further catalytically active species is selected from the group consisting of zinc di-tert butyl salicylate, zinc acetyl acetonate and zinc neodecanoate.

13. The process of claim 7, wherein said protective gas is nitrogen.

14. The process of claim 8, wherein said aliphatic isocyanate is selected from the group consisting of 1-n-octyl isocyanate, 1-n-decyl isocyanate, 1-n-octyl isocyanate and 1-stearyl isocyanate.
